(19) United States
(12) Patent Application Publication
(10) Pub. No.: US 2008/0149853 A1
(43) Pub. Date: Jun. 26, 2008

(54) Light shaping apparatus

(75) Inventors: David E. Hebert, Boise, ID (US); Gary L. Chadwick, Boise, ID (US)

Correspondence Address: BROOKS, CAMERON & HUEBSCH , PLLC, 1221 NICOLLET AVENUE, SUITE 500, MINNEAPOLIS, MN, 55403, US

(73) Assignee: Micron Technology, Inc.

(21) Appl. No.: 11/642,078

(22) Filed: Dec. 20, 2006

(51) Int. Cl. G21G 5/00

(52) U.S. Cl. 250/492.1

(57) ABSTRACT

Light shaping apparatuses and methods and testing apparatuses are described. In one embodiment, a light shaping apparatus includes a diffuser to diffuse an intensity of a light passed through the diffuser, and an aperture forming layer having a first surface and a second surface and having an aperture formed therebetween wherein the first surface is adjacent to a surface of the diffuser, and wherein the aperture is oriented to direct the light from the diffuser toward a light receiving surface of an imaging device.

### TECHNICAL FIELD

The present invention relates generally to light shaping apparatuses for illuminating imaging devices and, in particular, embodiments of the present disclosure relate to light shaping apparatuses for illuminating imaging devices during testing.

### BACKGROUND

During the manufacture of imaging devices (e.g., solid-state imagers), such as a Complementary Metal Oxide Semiconductor (CMOS) or a Charge Coupled Device (CCD), the testing of the photoelectric conversion portion of the device is often accomplished. In such manufacturing processes, the imaging device is often formed on a semiconductor wafer. Accordingly, the testing of the photoelectric conversion portion and the other components of the device can be tested at the same time, or in a sequence.

The testing of one or more other components is, for example, performed by a probe card. If the testing apparatus (e.g., probe card) has testing components to complete the photoelectric conversion portion and the other components, the testing apparatus may be maintained in the same position and, thereby, testing can be accomplished more quickly, among other benefits.

In such tests, a test light from a light source can be directed to a light receiving surface (e.g., an active area) of the imaging device through an aperture in the testing apparatus. However, the light used for testing is typically not similar to the light that will actually be received by the imaging device in the field. Accordingly, although the device may pass the test measures, it may be that the device is not suitable for some applications.

For example, such testing apparatuses utilize one or more lenses to direct the light toward the light receiving surface. These lenses can create too much intensity over a portion of or the entire light receiving surface. Further, since the probe card and/or a socket board are typically positioned between the light source and the imaging device, the degree of freedom of orientation is restricted.

Additionally, in some testing processes, a collimated light is used to perform the test. In some instances (e.g., as pixel size has decreased, while the chief ray angle of the testing apparatus remained substantially the same) the intensity of the light projected on the imaging device tended to increase to the point where the imaging device became difficult to test.

### BRIEF DESCRIPTION OF THE DRAWINGS

FIG. 1A is an exploded view of a light shaping apparatus according to an embodiment of the present disclosure.

FIG. 1B is an assembled perspective view of the embodiment illustrated in FIG. 1A.

FIG. 2A is an overhead view of an imaging device that may be used with the embodiments of the present disclosure.

FIG. 2B is a cut-away side view of the imaging device of FIG. 2A taken along line 2B-2B.

FIG. 3 illustrates the orientations of various components of the testing apparatus and a device under test of an embodiment of the present disclosure.

FIG. 4 illustrates a cut-away side view of a testing apparatus performing a test on an imaging device according to an embodiment of the present disclosure.

FIG. 5 illustrates a cut-away side view of another embodiment of a testing apparatus for performing a test on an imaging device according to an embodiment of the present disclosure.

FIG. 6 illustrates a graph of an aperture CRA versus an imager CRA in accordance with an embodiment of the present disclosure.

FIG. 7 is an overhead view of an active area of an imaging device under test that may be used with the embodiments of the present disclosure.

FIG. 8 is a side perspective view of the active area of the imaging device under test of FIG. 7.

FIG. 9 illustrates a graph of a lower angle of incidence, an upper angle of incidence, and an imager CRA in accordance with an embodiment of the present disclosure.

### DETAILED DESCRIPTION

The present disclosure includes various apparatuses and methods for shaping light. Embodiments of the present disclosure can be used to direct light at an imaging device under test, for example, during a manufacturing or post-manufacturing process.

Embodiments of the present disclosure can utilize a diffuser located adjacent to an aperture through which the light is directed at the imaging device. Embodiments can also be arranged such that light from a light source can directly enter the diffuser from the light source.

This can be advantageous in some applications, for example, where a lens would get dirty or dusty. Also, light that has not been through a lens may, in some instances be more like the light that will be directed toward the imaging device in the field and therefore, the test may be more indicative of field conditions. Embodiments that do not use a lens, typically also have less components and therefore may have less maintenance issues and be less expensive.

In some embodiments, the light may be collimated before it is directed into the diffuser. In such embodiments, the collimated light can be directed to the imaging device in a more predictable manner, which may be desirable for some types of testing.

In some embodiments, a light shaping apparatus can include a diffuser to diffuse an intensity of a light passed through the diffuser. Such embodiments can also include an aperture forming layer having a first surface and a second surface and having an aperture formed therebetween. In such embodiments, the apparatus can be designed such that the first surface is adjacent to a surface of the diffuser.

The aperture can be oriented to direct the light from the diffuser toward a light receiving surface of an imaging device. If a collimated light source is desired, the light can be collimated at the light source or after the light leaves the light source.

The apparatus can include a test fixture having a number of sets of diffusers and apertures that receive light from a single light source or multiple sources. For example, the apparatus can include a test fixture having a number of sets of diffusers and apertures that receive each receive light from different light sources.

The diffuser can be of various shapes. For example, the diffuser can be a cylindrical shaped diffuser. Such embodiments, can, in some instances, present a more uniform light intensity distribution to the imaging device, among other benefits.

The diffuser can be arranged in various positions with respect to the other components of the apparatus. For example, in some embodiments, the end surface of the diffuser is adjacent to the aperture. The diffuser can, for instance, be positioned such that the light enters the diffuser directly from a light source.

The diffuser can be made from a variety of suitable materials. For example, in some embodiments, the diffuser can be made from glass. A glass such as an opal glass material is one example of a suitable glass type material. In some embodiments, a Lambertian profile may be desirable and an opal glass material can be used in such embodiments.

The present disclosure also includes a number of testing apparatus embodiments. In such embodiments, the testing apparatus can include a number of testing components. For instance, a testing device can include a probe portion having a number of contact probes thereon for contacting pads on an imaging device.

In some embodiments, the testing device can have an imaging test portion. In such embodiments, the imaging test portion can, for example, have a light source, a diffuser to diffuse an intensity of a light generated by the light source and directly passed through the diffuser, and an aperture forming layer having a first surface and a second surface and an aperture formed therebetween.

When a probe portion and an imaging test portion are provided together, the probe portion and the imaging test portion can, for example, be positioned such that at least one contact probe can be in contact with a pad while light is being directed from the diffuser toward the light receiving surface of the imaging device. Such embodiments can allow for simultaneous, parallel, or serial testing by the probe portion and the imaging test portion, which, in some instances can save time during the manufacturing or post-manufacturing process, among other benefits.

In some light shaping apparatus embodiments, the light shaping apparatus can include a diffuser to diffuse an intensity of a light passed through the diffuser and an aperture forming layer having a first surface and a second surface and having an aperture formed therebetween. In some such embodiments, the first surface is adjacent to a surface of the diffuser.

In various embodiments, the aperture can be oriented to direct the light from the diffuser toward a light receiving surface of an imaging device, where a chief ray angle of the imaging device is between an upper angle of incidence and a lower angle of incidence of light contacting the light receiving surface. In such embodiments, having the chief ray angle within the upper and lower angles of incidence can be beneficial because the light directed toward the imaging device covers the surface of the active area of the device with light that is properly oriented to each pixel location on a die.

The chief ray angle of the imaging device that is to be tested can be used with respect to the positioning of the various components of the apparatus. For example, the diameter of the aperture can be sized based upon an analysis of the chief ray angle of the imaging device and a comparison of the chief ray angle to the lower angle of incidence and the upper angle of incidence of the aperture.

In some embodiments, The aperture can have a diameter that is sized based upon the chief ray angle of the imaging device and a distance of the aperture from the imaging device. Additionally, the aperture can have a distance from the imaging device that is based upon the chief ray angle of the imaging device and a diameter of the aperture, in some embodiments.

The present disclosure also includes a number of method embodiments. For example, in some method embodiments, the method can include generating a light from a light source passing the light directly through a diffuser, and passing the light from the diffuser through an aperture, wherein the aperture is oriented to direct the light from the diffuser toward a light receiving surface of an imaging device.

Method embodiments can include determining an aperture diameter that defines a light cone that envelops a chief ray angle of the imaging device across a diagonal of the light receiving surface. A testing apparatus chief ray angle can be based upon taking an arc tangent of an image height of the imaging device divided by a distance of the aperture from the imaging device and such calculating processes can be perform in some embodiments.

Methods of determining the aperture size and position can be provided. For example, methods can include determining an aperture diameter based upon a chief ray angle of the imaging device and a distance of the aperture from the imaging device. In some embodiments, a method can include determining a distance for positioning the aperture from the imaging device based upon a chief ray angle of the imaging device and a diameter of the aperture.

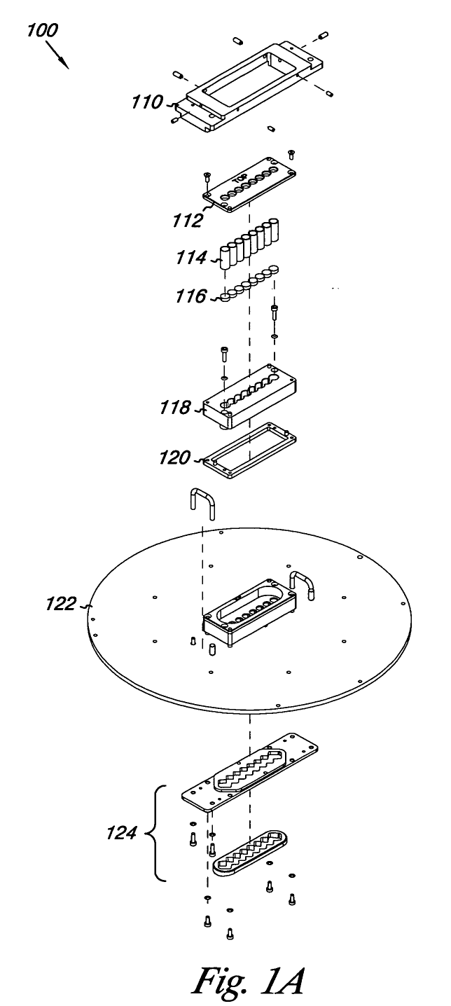

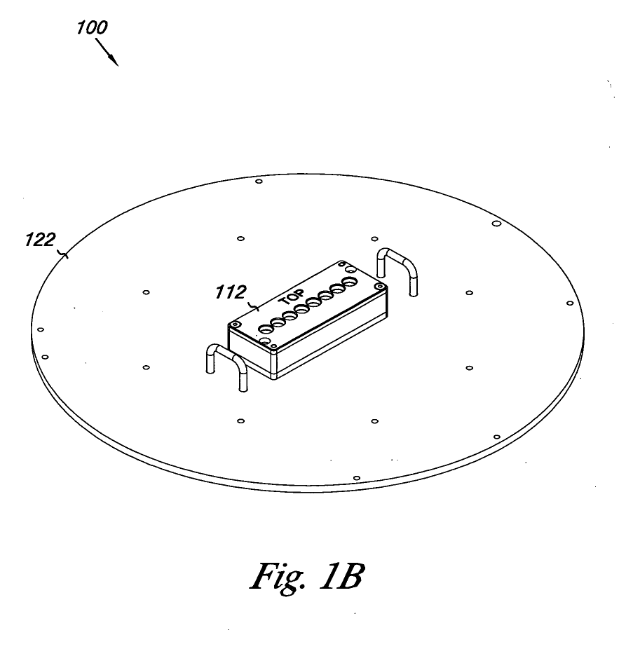

FIG. 1A is an exploded view of a light shaping apparatus according to an embodiment of the present disclosure. The light shaping apparatus can include a number of components. For example, in the embodiment of FIG. 1A, the testing apparatus 100 is a light shaping apparatus that includes an alignment fixture 110, a retainer plate 112, a diffuser retainer 114, a diffuser 116, a diffuser mounting structure 118, and a mounting plate 120. In the embodiment illustrated in FIG. 1A, these components are mounted to one surface of a test card 122 (e.g., probe card). In the illustrated embodiment of FIG. 1A, stiffening structure components 124 are mounted to another surface of the test card 122.

One or more alignment fixtures, such as fixture 110, can be used to make adjustments to the alignment of the diffusers and/or apertures in order for them to be aligned with respect to the light source. This can be beneficial, in some embodiments, because the test card 122 does not have to be moved, and/or, in some embodiments, the diffusers and apertures can be aligned without taking the apparatus apart, among other benefits.

Also, as illustrated in the embodiment of FIG. 1A, stiffening components can be used to stiffen the apparatus 100. This can be beneficial in embodiments that may be subject to forces that may damage the apparatus 100.

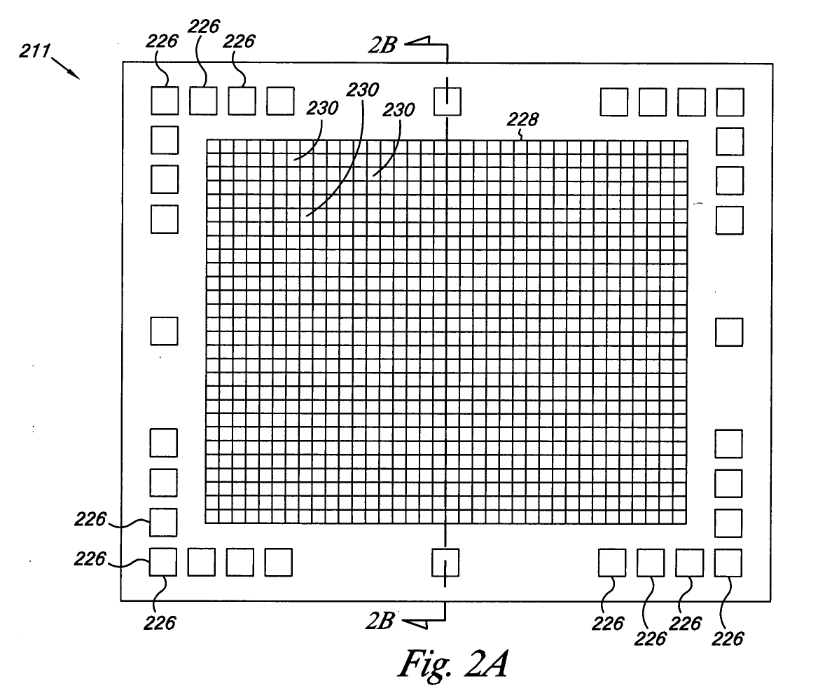

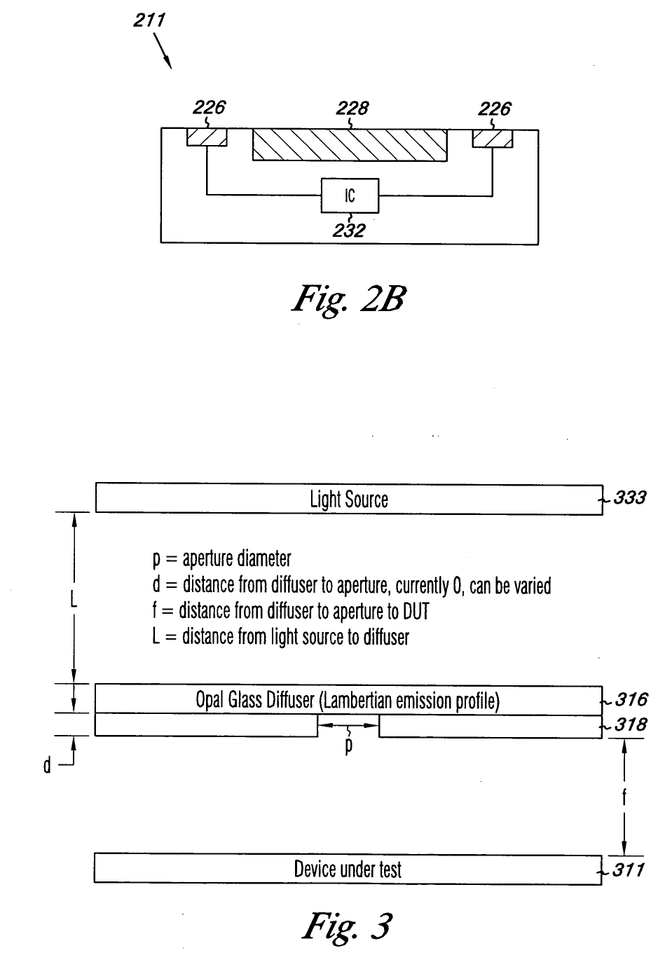

When the apparatus is assembled, it functions to receive light from a light source (not shown) through the holes in the retainer plate 112. That light is passed through the diffuser 116 and apertures, as will be discussed in more detail below, formed in the diffuser mounting structure 118. The apparatus 100 directs light toward an imaging device, described in more detail in FIGS. 2A and 2B below.

FIG. 1B illustrates an assembled perspective view of the embodiment illustrated in FIG. 1A. In the embodiment of FIG. 1B, a few components are illustrated to allow correlation to those components in FIG. 1A. For example, the apparatus 100 includes a retainer plate 112 and the apparatus is mounted on the surface of a test card 122 (e.g., probe card).

FIG. 2A is an overhead view of an imaging device that may be used with the embodiments of the present disclosure. Imaging devices can include a number of components. For example, in the embodiment illustrated in FIG. 2A, the imaging device 211 includes an active area 228 having a number of pixels 230 for receiving light and measuring the light intensity at each pixel.

The imaging device also can include a number of contacts thereon. The contacts are used to create paths to and from the imaging device and other devices of a larger system. For example, some contacts can be used to provide power, from a power source, to the imaging device in order to power its circuitry.

FIG. 2B is a cut-away side view of the imaging device of FIG. 2A taken along line 2B-2B. In this Figure, the components of the imaging device 211 from FIG. 2A are viewable, namely, the active area 228 and the contacts 226.

Also illustrated is an integrated circuit 232 that is used to execute instructions. The integrated circuit 232 can be operably coupled to the active area 228 to execute instructions regarding the use of the pixels within the active area 228. The imaging sensor 211 can be of various types. For example, imaging devices can be solid state-type devices such as complementary metal-oxide-semiconductor (CMOS) devices, charged coupled device (CCD) image sensors, or other imaging device types for capturing images in the visible (e.g., visible to the human eye) or non-visible spectrum (e.g., Infrared or Ultra-violet).

FIG. 3 illustrates the orientations of various components of the testing apparatus and a device under test of an embodiment of the present disclosure. Such testing systems can have a number of components. For example, the embodiment illustrated in FIG. 3, includes a light source 333, an opal glass diffuser 316, an aperture layer 318, and a device under test 311.

In such embodiments, the light source 333 can be any suitable type. For example, a light emitting diode (LED) is one suitable type of light source for providing light to the device under test (DUT) 311. Another example is a halogen light, such as a collimated halogen light source.

Additionally, as stated above, some testing systems can utilize multiple light sources. For instance, a different light source can be associated with each aperture, in some embodiments.

With respect to the aperture forming layer, the layer can have a thickness or can be as thin as practical. The aperture layer has a first surface (e.g., a top surface), a second surface (e.g., a bottom surface), and the aperture is formed through both the first and second layers and spans therebetween. In some embodiments, the aperture measurements can be made from the top surface and/or from the bottom surface.

Also illustrated in the embodiment of FIG. 3 are a number of dimensions of the testing system. For example, the system illustrated in FIG. 3 includes and aperture diameter (p), a distance from the diffuser to the aperture (d), a distance from the diffuser to the device under test (f), and a distance from the light source to the diffuser (L).

These dimensional elements can be used in designing the system, or testing apparatus or in adjusting the positions of the various components, for example, based upon use of the testing apparatus with different types of imaging devices. For example, the aperture size (e.g., based upon diameter, circumference, etc.) can be designed such that the resulting directed light (e.g., a light cone) projects over the entire surface of the imaging device, in some embodiments.

The aperture distance from the device under test can also be used to create the suitable projection over the device under test. Some calculations based upon these elements are discussed elsewhere in this disclosure.

In various embodiments, the aperture diameter can be adjustable or fixed. In some embodiments, an aperture forming layer can be replaced with another layer having a different sized aperture or a layer of a different thickness. The aperture forming layer can also include an iris for changing the aperture diameter, in some embodiments.

Further, in various embodiments, an aperture forming layer can be positioned adjacent to the diffuser or spaced therefrom. In some embodiments, the spacing can be adjusted by a suitable movable mechanism for moving the layer, or changed by removing one layer and replacing it with one or more other layers to provide a different spacing. The other dimensional elements discussed above can also be fixed or adjustable, in similar manners, in various embodiments.

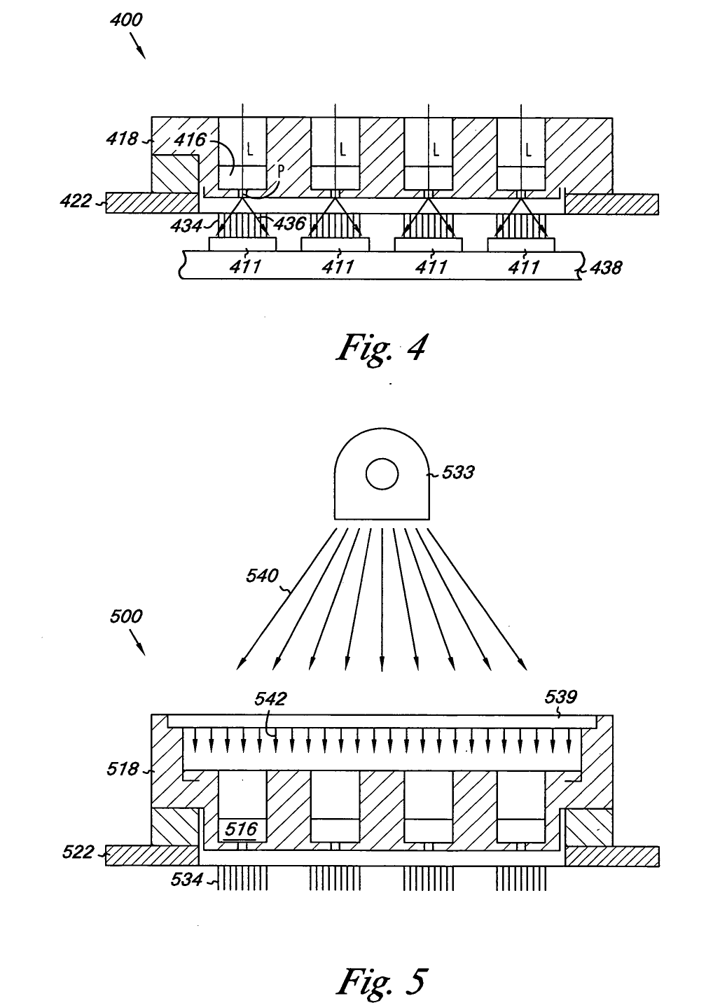

FIG. 4 illustrates a cut-away side view of a testing apparatus performing a test on an imaging device according to an embodiment of the present disclosure. In the system embodiment illustrated in FIG. 4, the system includes a testing apparatus 400, having multiple apertures of diameter p, positioned over a number of imaging devices 411.

The testing device 400 that is illustrated in FIG. 4 includes a test card 422 that is a probe card and includes a number of probes 434 for contacting each of the imaging devices 411. The probes 434 can, for example, be used to measure the photoelectric conversion characteristics of the imaging device when light is directed to the imaging device.

In FIG. 4, the testing apparatus includes a mounting structure 418 having a number of cavities and with each cavity having an aperture formed therein. In such embodiments, the aperture layer is part of another component (e.g., a portion of the mounting structure). This structure can be beneficial in some embodiments because the apertures can all be aligned with one another and can be aligned with respect to the diffuser 416 that is associated with each aperture.

One or more diffusers 416 can be placed within the number of cavities to diffuse light directed from one or more light sources (not shown). In such embodiments, one or more diffuser retainers (e.g., such as that shown in the embodiment of FIG. 1A) can also be placed within the cavity. The diffuser retainers can be transparent or tubular shaped, to allow the light from the light source to pass to the diffuser.

If a transparent diffuser retainer is used, it may aid in keeping the diffuser free from dirt, debris, and other contaminants. In such embodiments, it may be easier and more cost effective to replace the diffuser retainer rather the diffuser itself. Further, in some embodiments, the diffuser retainer may be made from a material that is more receptive to cleaning and therefore it can protect the diffuser from potential damage due to cleaning.

The light sources are identified as being a distance L from the aperture. In some embodiments, the distance L will be a vertical distance to the light source even though the light source may not be directly above the aperture to which the measurement is associated.

The embodiment of FIG. 4 also illustrates a light cone 436 created by the aperture. The light cone, in the embodiment of FIG. 4, does not project over the entire surface of the imaging device, but in some testing situations, the active area (i.e., the area that senses light) may cover less than an entire surface (e.g., top surface) of the imaging device (e.g., such as the imaging device of FIGS. 2A and 2B). In such embodiments, it may be suitable to project the light cone over the entire active area of the imaging device, but not the entire surface of the device.

FIG. 5 illustrates a cut-away side view of another embodiment of a testing apparatus for performing a test on an imaging device according to an embodiment of the present disclosure. The apparatus of FIG. 5 includes a testing device 500 having a test card 522 that is a probe card and includes a number of probes 534. The testing apparatus also includes a mounting structure 518 having a number of cavities and with each cavity having an aperture formed therein.

As with the embodiment illustrated in FIG. 4, the embodiment of FIG. 5 also allows for one or more diffusers 516 to be placed within the number of cavities to diffuse light directed from one or more light sources. In the embodiment of FIG. 5, a single light source 533 is used and the light 540 is collimated by a collimating structure 538.

The collimating structure 538 collimates the light 542 that is directed into the cavities containing the diffusers 516. In some apparatus or system embodiments, the testing apparatus can have one or more diffusers and one or more light sources. The collimated light can be passed through the diffusers 516 and apertures and toward associated imaging devices (not shown).

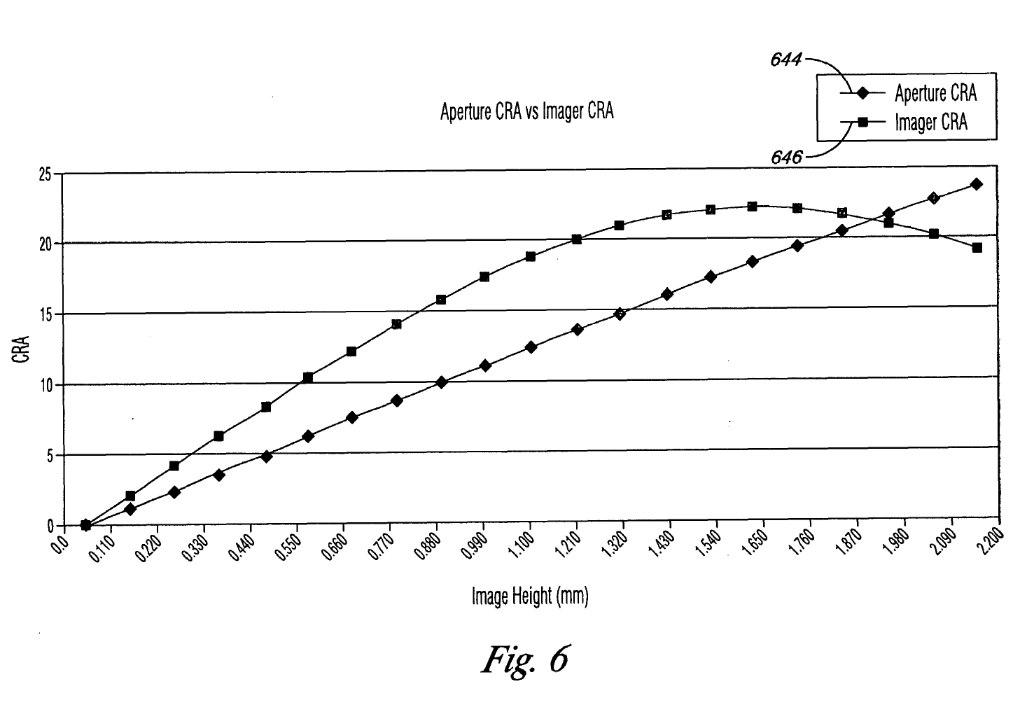

FIG. 6 illustrates a graph of an aperture CRA versus an imager CRA in accordance with an embodiment of the present disclosure. In designing or adjusting a testing apparatus, a number of different method embodiments can be utilized to calculate the positioning of the various apparatus or system components.

For example, the light cone presented to the imaging device (e.g., light cone 436 of the apparatus embodiment of FIG. 4) can be compared to the chief ray angle of a device to be tested (imager CRA) by the apparatus. Imager CRAs, in some instances, can be provided by the imaging device manufacturer and are well known in the art.

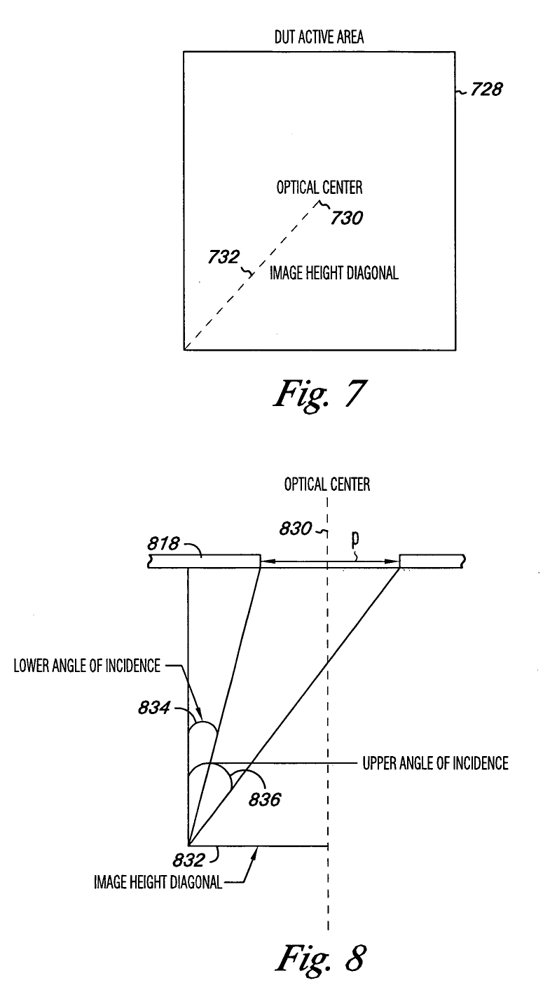

Some imaging devices have lenses (e.g., a microlens) formed or attached above the active area of the device. In such instances, the imager CRA can be calculated as the chief ray angle of the light focused onto the active area of the device (e.g., light sensor array) by the microlens of the device, given the distance from the optical center of the active area, defined by the image height, for example, as can be accomplished with the method described in FIGS. 7 and 8 below among other methods.

The information in the graph of FIG. 6 illustrates that it may be beneficial, in some embodiments, to reduce or minimize the difference between the CRA of the imager and the CRA of the apparatus. In this way, the light cone may be sized to project over much of or the entire active area, in some embodiments.

FIG. 7 is an overhead view of an active area of an imaging device under test that may be used with the embodiments of the present disclosure. This illustration describes how the dimensions of a device to be tested can be used to calculate the positioning of one or more components of the apparatus or system.

As shown in FIG. 7, the device to be tested has an active area 728 an optical center 730, and an image height diagonal 732 (i.e. image height). Assuming, the apparatus is centered on the optical center of the device under test, upper and lower incidence angles can be calculated.

For example, the angles can be calculated by finding the angle of incidence from both edges of the aperture to points along the image height. In such embodiments, the centering of the apparatus can be determined by whether the center of the aperture associated with the device under test is centered over the optical center of the active area. In some embodiments, these calculations can be based upon a theoretical device, such as if the calculation is being done before the apparatus is constructed or before a device is associated with the testing apparatus.

FIG. 8 is a side perspective view of the active area of the imaging device under test of FIG. 7. FIG. 8 includes side views of the optical center 830, the image height diagonal 832, and the aperture layer 818 having an aperture with the width p. In this view, the orientation and calculation of a lower 834 and an upper 836 angle of incidence are shown.

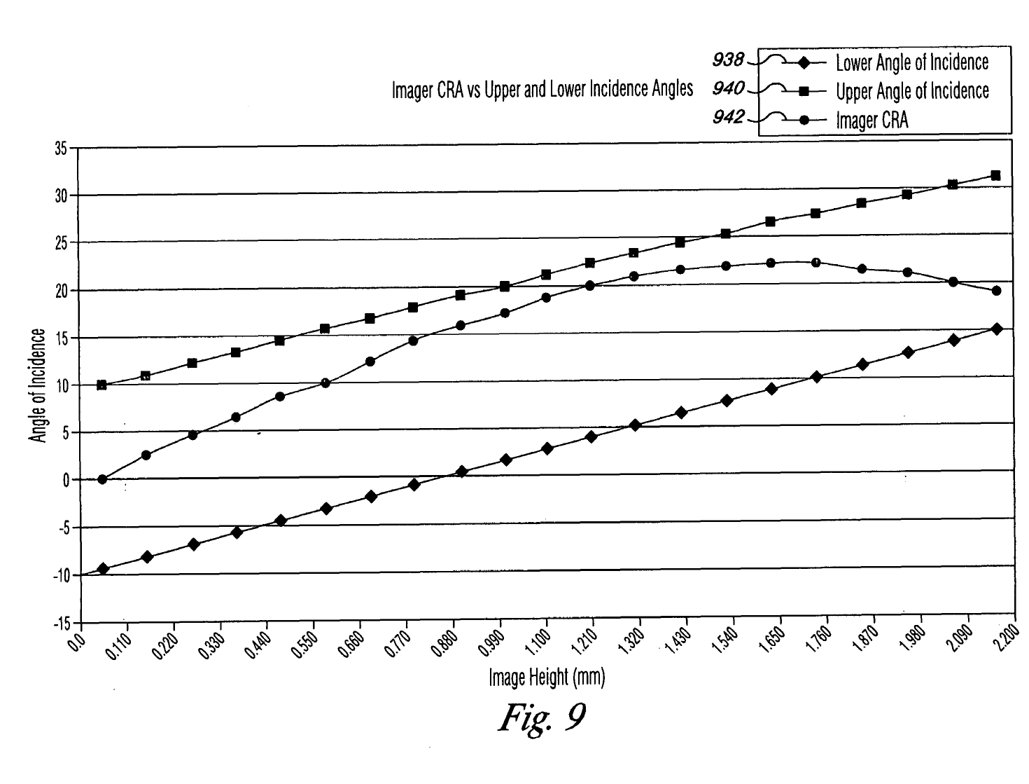

FIG. 9 illustrates a graph of a lower angle of incidence, an upper angle of incidence, and an imager CRA in accordance with an embodiment of the present disclosure. The lower and upper angles of incidence can be used in some embodiments to determine how much of the active area is projected upon by the light cone.

For example, in the graph of FIG. 9, the information illustrates that the imager CRA for the embodiment measured to obtain the data of this graph is between the lower and upper angles of incidence of the testing apparatus over the entire imager height. This means that the light cone projects over all of the active area. Through use of such computations, the dimensions and positions of the various apparatus or system components can be changed or adjusted to provide the desired projection over the active area.

### CONCLUSION

The present disclosure includes various apparatuses and methods for shaping light. Embodiments of the present disclosure can be used to direct light at an imaging device under test, for example, during a manufacturing or post-manufacturing process.

Embodiments of the present disclosure can be advantageous in some applications, for example, where a lens would get dirty or dusty. Also, light that has not been through a lens may, in some instances, be more like the light that will be directed toward the imaging device in the field and therefore, the test may be more indicative of field conditions.

Embodiments that do not use a lens, typically also have less components and therefore may have less maintenance issues and be less expensive. Embodiments, can, in some instances, present a more uniform light intensity distribution to the imaging device, among other benefits.

Embodiments having probing capabilities can allow for simultaneous, parallel, or serial testing by the probe portion and the imaging test portion, which, in some instances, can save time during the manufacturing or post-manufacturing process, among other benefits. The present disclosure also includes embodiments, having the chief ray angle of the imaging device within the upper and lower angles of incidence of the aperture, which can be beneficial because the light directed toward the imaging device covers the surface of the active area of the device.

The dimensional elements of an imaging device or system can be calculated to provide the desired coverage of light upon a device under test. This can be accomplished, for example, prior to building the testing apparatus or system or when the device or system is adjusted.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A light shaping apparatus, comprising:
a diffuser to diffuse an intensity of a light passed through the diffuser; and
an aperture forming layer having a first surface and a second surface and having an aperture formed therebetween wherein the first surface is adjacent to a surface of the diffuser; and
wherein the aperture is oriented to direct the light from the diffuser toward a light receiving surface of an imaging device.

2. The light shaping apparatus of claim 1, wherein the apparatus includes a test fixture having a number of sets of diffusers and apertures that receive light from a single light source.

3. The light shaping apparatus of claim 1, wherein the apparatus includes a test fixture having a number of sets of diffusers and apertures that receive each receive light from different light sources.

4. The light shaping apparatus of claim 1, wherein the diffuser is a cylindrical shaped diffuser.

5. The light shaping apparatus of claim 3, wherein an end surface of the diffuser is adjacent to the aperture.

6. The light shaping apparatus of claim 1, wherein the diffuser is positioned such that the light enters the diffuser directly from a light source.

7. A testing apparatus, comprising:
a probe portion having a number of contact probes thereon for contacting pads on an imaging device; and
an imaging test portion having:
a light source;
a diffuser to diffuse an intensity of a light generated by the light source and directly passed through the diffuser; and
an aperture forming layer having a first surface and a second surface and having an aperture formed therebetween wherein the first surface is adjacent to a surface of the diffuser; and
wherein the aperture is oriented to direct the light from the diffuser toward a light receiving surface of an imaging device.

8. The testing apparatus of claim 7, wherein the probe portion and the imaging test portion are positioned such that at least one contact probe can be in contact with a pad while light is being directed from the diffuser toward the light receiving surface of the imaging device.

9. The testing apparatus of claim 7, wherein the diffuser is constructed from a glass material.

10. The testing apparatus of claim 7, wherein the diffuser is constructed from an opal glass material.

11. The testing apparatus of claim 7, wherein the diffuser provides a Lambertian emission profile.

12. The testing apparatus of claim 7, wherein the light source includes a collimating structure.

13. The testing apparatus of claim 7, wherein the imaging test portion includes a collimating structure.

14. A light shaping apparatus, comprising:
a diffuser to diffuse an intensity of a light passed through the diffuser; and
an aperture forming layer having a first surface and a second surface and having an aperture formed therebetween wherein the first surface is adjacent to a surface of the diffuser; and
wherein the aperture is oriented to direct the light from the diffuser toward a light receiving surface of an imaging device and wherein a chief ray angle of the imaging device is between an upper angle of incidence and a lower angle of incidence of light contacting the light receiving surface.

15. The light shaping apparatus of claim 14, wherein the aperture has a diameter that is sized based upon an analysis of the chief ray angle of the imaging device and a comparison of the chief ray angle to the lower angle of incidence and the upper angle of incidence of the aperture.

16. The light shaping apparatus of claim 14, wherein the aperture has a diameter that is sized based upon the chief ray angle of the imaging device and a distance of the aperture from the imaging device.

17. The light shaping apparatus of claim 14, wherein the aperture has a distance from the imaging device that is based upon the chief ray angle of the imaging device and a diameter of the aperture.

18. The light shaping apparatus of claim 14, wherein the apparatus includes an alignment fixture.

19. The light shaping apparatus of claim 14, wherein the apparatus includes a diffuser retainer.

20. The light shaping apparatus of claim 14, wherein the aperture forming layer is a portion of a diffuser mounting structure.

21. The light shaping apparatus of claim 14, wherein the apparatus includes a number of stiffening structure components.

22. A method, comprising:
generating a light from a light source;
passing the light directly through a diffuser; and
passing the light from the diffuser through an aperture, wherein the aperture is oriented to direct the light from the diffuser toward a light receiving surface of an imaging device.

23. The method of claim 22, wherein the method further includes, determining an aperture diameter that defines a light cone that envelops a chief ray angle of the imaging device across a diagonal of the light receiving surface.

24. The method of claim 23, wherein the method includes adjusting the aperture diameter.

25. The method of claim 23, wherein the method includes replacing a first aperture forming layer having an aperture with a first diameter with a second aperture forming layer having an aperture with a second diameter.

26. The method of claim 22, wherein the method includes calculating a testing apparatus chief ray angle based upon taking an arc tangent of an image height of the imaging device divided by a distance of the aperture from the imaging device.

27. The method of claim 26, wherein the method includes adjusting the distance of the aperture from the imaging device.

28. The method of claim 22, wherein the method includes determining an aperture diameter based upon a chief ray angle of the imaging device and a distance of the aperture from the imaging device.

29. The method of claim 22, wherein the method includes determining a distance for positioning the aperture from the imaging device based upon a chief ray angle of the imaging device and a diameter of the aperture.

30. The method of claim 29, wherein the method includes positioning the aperture the determined distance from the imaging device by adjusting the spacing between an aperture forming layer having the aperture formed therein and the imaging device.

31. The method of claim 29, wherein the method includes positioning the aperture the determined distance from the imaging device by replacing a first aperture forming layer having the aperture formed therein with a second aperture forming layer having an aperture formed therein and wherein the second aperture forming layer is constructed such that the distance of the aperture from the imaging device is the determined distance.
